(19) United States
(12) Patent Application Publication
(10) Pub. No.: US 2002/0093418 A1
(43) Pub. Date: Jul. 18, 2002

(54) Motor vehicle door lock system

(76) Inventors: Stephan Schmitz, Koln (DE); Christian Gerhardt, Hattingen (DE)

Correspondence Address: NIXON PEABODY, LLP, 8180 GREENSBORO DRIVE, SUITE 800, MCLEAN, VA, 22102, US

(21) Appl. No.: 09/725,263

(22) Filed: Nov. 29, 2000

(30) Foreign Application Priority Data
Nov. 29, 1999 (DE) 199 57 419.7

(51) Int. Cl. H04Q 1/00

(52) U.S. Cl. 340/5.62; 340/5.61

(57) ABSTRACT

A motor vehicle door lock system whereby at least one of spatial proximity of an operator to the outside door handle and a physical touching of the outside door handle by the operator can be easily detected using a comparatively low power source exhibiting excellent response behavior. One aspect includes a passive entry function of the motor vehicle door lock system can be activated or a starting interval of the control electronics can be initiated. The lock system utilizes ultrasonic waves for the detection of the at least one of spatial proximity of an operator to the outside door handle and a physical touching of the outside door handle by the operator. To sense spatial proximity to the outside door handle and/or touching of the outside door handle at least essentially solely in the access space defined by the outside door handle, an ultrasonic field is produced whereby changes and/or interruptions of the ultrasonic field is detected upon the occurrence of these events.

### BACKGROUND OF THE INVENTION

1. Field of the Invention

This invention relates generally to a motor vehicle door lock system, including a door lock and a outside door handle. In particular, the invention relates to a motor vehicle door lock system whereby the spatial proximity of the hand of the operator with regard to the outside door handle and/or the actual touching of the outside door handle by the operator can be easily detected using a comparatively low power source having excellent response behavior.

2. Description of the Related Art

Electromechanical motor vehicle door lock systems having radio activated remote control but lacking a passive entry function are well known. In these conventional vehicle door lock systems, the operator presses a button on a remote control module, which activates the control electronics by causing the control electronics to pass through its reaction phase immediately. Based upon the distance of the operator when the remote control module button is pressed, the operator reaches the outside door handle on the motor vehicle door with such a long time delay that the reaction phase of the control electronics has long been completed and the motor vehicle lock has been unlocked. By pulling on the outside door handle the operator opens the motor vehicle door, the motor vehicle lock opens either mechanically, whereby the detent pawl is lifted by the motion of the outside door handle, or electromechanically or pneumatically, whereby the outside door handle delivers a control signal to the opening drive to raise the detent pawl.

Control electronics having a so-called passive entry function, also called an “electronic key”, differs from the above explained conventional electromechanical motor vehicle door lock system in that on the remote control module no manipulation is necessary, therefore a button need not be pressed to unlock the motor vehicle lock when approaching the motor vehicle. Rather, the unlocking of the motor vehicle lock occurs automatically simply when the operator approaches the motor vehicle.

Accordingly, a passive entry function is defined especially as automatic, vehicle-side data interrogation or identification of an operator-side data medium, transponder or the like in order to ascertain whether an operator approaching the motor vehicle or an operator already engaged in the process of opening the vehicle door is authorized for access. This is generally checked by the corresponding electronics of the motor vehicle. With corresponding authorization of the operator, ordinarily automatic unlocking takes place either by a central interlock system of the door lock of the driver-side door, or at least of the door lock of any door being approached by the operator and any door whose outside handle the operator is touching or activating.

A motor vehicle door lock system with a passive entry function requires for the control electronics a certain reaction phase or time which is composed of: a starting interval to activate the system as the data medium or remote control module approaches; an authorization check interval to check the operator for his authorization using the coding of signals exchanged between the remote control module and the control electronics; and an actual action interval in which the unlocking of the motor vehicle lock is carried out.

A corresponding reaction phase is also required when locking the vehicle door lock system, the reaction phase occurring in a manner that is essentially unnoticed by the operator. The length of the reaction phase is approximately more than one hundred milliseconds and is perceived as long as the starting interval is initiated only upon activating the outside door handle. Pulling the outside door handle or the like can take place in a passive entry function under certain circumstances when the reaction phase of the control electronics has not yet been completed. The operator must then pull the door handle a second time; this can be interpreted as a “malfunction”. Since the resulting total time of the reaction phase cannot be shortened as much as desired, attempts have already been made to conceal the delay time.

Published German Patent Application DE 95 21 024 discloses a motor vehicle door lock system wherein the starting interval and the authorization check interval of the control electronics are shifted into a phase which precedes the actual operation phase which is noticeable to the operator. Accordingly, the remaining time which corresponds to the reaction time of a conventional mechanical motor vehicle door lock system is noticeable to the operator.

A different approach is to have the starting interval of the control electronics initiated not only when the outside door handle is activated, but also when the hand of an operator approaches the outside door handle. This is accomplished by providing a capacitive proximity sensor on the outside door handle. Published German Patent Applications DE 197 52 974 and DE 196 17 038 each disclose such motor vehicle door lock systems wherein the approach of the hand of the operator is acquired roughly 100-150 ms prior to the hand touching the outside door handle. Consequently, the starting interval of the control electronics, i.e., the “awakening” of the control electronics, begins so far ahead of the actual pulling of the outside door handle that the starting interval and usually the authorization check interval are already completed once the outside door handle is moved by the hand of the operator.

Because external effects such as rain, snow, dirt and dust greatly change the measured values greatly in capacitive proximity sensors, comparatively high complexity is necessary to ensure proper operation. The use of capacitive proximity sensors in motor vehicle door lock systems is conventional, but entails various difficulties. While the proximity sensors utilize a comparatively high closed-circuit current, it is difficult to set a stable, unequivocal response threshold, and is also expensive. Moreover, due to the use of a comparatively high closed-circuit current, high circuit complexity is necessary, which leads to high costs. Finally, capacitive proximity sensors also emit electromagnetic radiation, which causes interference.

Based upon the aforementioned difficulties, motor vehicle door lock systems with a passive entry function in which only touching or actuating the outside door handle by the hand of an operator begins the starting interval of the control electronics also have major advantages.

U.S. Pat. No. 4,868,915 discloses a keyless access system for motor vehicles and includes a passive entry function. The access system has an antenna and an identification means for checking the access authorization of an operator-side data medium if an operator with a data medium is in the monitoring area, and a proximity sensor which activates the access system when an operator is in the monitoring area. While the proximity sensor is preferably a capacitive proximity sensor, magnetic, inductive, acoustic or similar proximity sensors can also be used. One preferred arrangement of the access system and thus also the proximity sensor in the area of the A column or the B column of a motor vehicle is disclosed. Finally it is a type of “antenna system” with wide-area emission.

### SUMMARY OF THE INVENTION

Accordingly, the object of this invention is to overcome the aforementioned disadvantages in devising a motor vehicle door lock system whereby the proximity of the hand of the operator with regards to an outside door handle, and/or the actual touching of the outside door handle by the hand of an operator can be easily detected using a comparatively low power demand and with good response behavior. An aspect of the invention includes a passive entry function of the motor vehicle door lock system can be activated or a starting interval of the control electronics can be initiated. The lock system utilizes ultrasonic waves for the detection of proximity of the hand of an operator with regards to an outside door handle, and/or the touching of the outside door handle by the hand of an operator in the near field.

In the present invention, “ultrasound” is defined as vibrations or sonic waves with frequencies above the audible range, for example, above approximately 16-20 kHz and preferably up to approximately 8×10⁹ Hz. This ensures that the acoustic waves emitted for detection purposes are not audible. Another advantage of the use of ultrasonic waves lies in that at a comparatively low power demand a favorable response behavior can be achieved with respect to the sensing of proximity or contact.

Another fundamental aspect of this invention is that at least essentially only in the area or in the vicinity of the outside door handle is an ultrasonic field generated. This enables extensive minimization of the power demand, since simply a comparatively small three-dimensional area must be monitored and sufficiently early detection of proximity or contact is still possible.

In particular, in accordance to the present invention an ultrasonic transducer is provided directly on the outside door handle for emitting and/or acquiring the ultrasonic waves. Here an “ultrasonic transducer” is defined as a component for converting electrical signals into ultrasonic waves or converting ultrasonic waves into electrical signals. “Acquisition” is defined as making available data or measurement signals, the evaluation of which enables detection or sensing of whether the hand of an operator has approached the outside door handle, or is already touching and/or activating the outside door handle. The evaluation can take place especially directly in electronics assigned to the sensor and/or in separate evaluation electronics or the like. This goes without saying for one skilled in the art so that it is not detailed here, since it is essentially irrelevant where the evaluation takes place. However, it is advantageous if the evaluation electronics which make available the corresponding detection signal is already integrated into the outside door handle or the outside door handle arrangement.

The preferably integrated arrangement of the ultrasonic transducer on the outside door handle enables comparatively simple refitting or introduction in motor vehicles already in production, since simply a correspondingly modified outside door handle with the assigned control and/or evaluation electronics must be used instead of a conventional outside door handle. Approaching the outside door handle and/or touching the outside door handle is preferably detected or acquired by one of the following possibilities or combinations. One simple and economical embodiment calls for the ultrasonic transducer to work both as a sensor and also as a receiver. Especially in pulsed generation of the ultrasonic waves can then the ultrasonic transducer work in the pulse pauses as a receiver. When the ultrasonic waves emitted by the ultrasonic transducer are reflected back by a section of the outside door handle and/or the door area adjacent to the outside door handle, such as the handle well, to the ultrasonic transducer, this can be evaluated in that the hand of the operator or the like does not interrupt the ultrasonic field or the propagation of the ultrasonic waves, therefore there is no proximity. The failure of reflected ultrasonic waves to appear and/or the change of the transit time, because for example the hand of an operator reaching into the ultrasonic field reflects the ultrasonic waves to the ultrasonic transducer, can be detected as proximity and/or contact.

Optionally, the rate of change of the transit time can be considered. The corresponding applies when ultrasonic waves are reflected back to the ultrasonic transducer solely by an approaching object to be detected, such as the hand of an operator, and not by the outside door hand and/or an adjacent door area. Occurrence of a reflection signal and optionally the change of its transit time then indicate proximity and/or touching. Alternatively or additionally to the ultrasonic transducer operating both as a transmitter and a receiver, there can be an additional ultrasonic transducer for acquiring the emitted ultrasonic waves. The at least two ultrasonic transducers are preferably then located on the outside door handle such that a photoelectric barrier-like ultrasonic field is formed, the interruption of which can be detected as a proximity and/or contact. The sonic propagation between the two ultrasonic transducers however need not run in a straight line. Rather also for example ultrasonic waves reflected on an adjacent door area, such as the handle well, are acquired by the additional ultrasonic transducer. In this case the transmitter and receiver can be located for example nearer to or directly next to one another.

Depending upon the combination of the aforementioned detection and evaluation possibilities, both proximity and contact can be easily sensed. Differentiation between proximity and contact can be done especially by evaluating transit times and/or the failure of reflection signals to appear. The sensing of proximity and/or touch enables early activation of the passive entry function and initiation of the starting interval of the control electronics. Thus, enough time is gained to unlock the motor vehicle lock for example before the operator in fact actuates the outside door handle to open the corresponding motor vehicle door or the motor vehicle lock.

The ultrasonic transducer can alternatively be located on a door area adjacent to the outside door handle, such as the handle well. The same applies when using several ultrasonic transducers as well. Thus, especially when this adjacent door area belongs to an outside door handle arrangement which is inserted as a separate part or separate unit into the assigned motor vehicle door, can installation into the motor vehicle door be simplified since the problem of establishing an electrical connection to the ultrasonic transducer in the outside door handle which is conventionally made movable is eliminated. When both proximity and also contact in succession are detected separately, the corresponding functions of the motor vehicle door lock system, the control electronics or for example other electronics of the motor vehicle can be activated in two stages, staggered in time.

Other aspects, properties, features and advantages of this invention follow from the explanation of preferred embodiments below which are shown in the drawings.

### BRIEF DESCRIPTION OF THE DRAWINGS

FIG. 1 shows in a schematic and perspective view a motor vehicle with a vehicle door lock system as claimed in the invention;

FIG. 2 shows an outside door handle arrangement in a motor vehicle door lock system as shown in FIG. 1;

FIG. 3 shows a schematic plan view of an outside door handle arrangement according to a first embodiment as claimed in the invention;

FIG. 4 shows a schematic plan view of an outside door handle arrangement according to a second embodiment as claimed in the invention;

FIG. 5 shows a side view of the outside door handle arrangement as shown in FIG. 4; and

FIG. 6 shows a schematic plan view of an outside door handle arrangement according to a third embodiment as claimed in the invention.

### DETAILED DESCRIPTION OF THE INVENTION

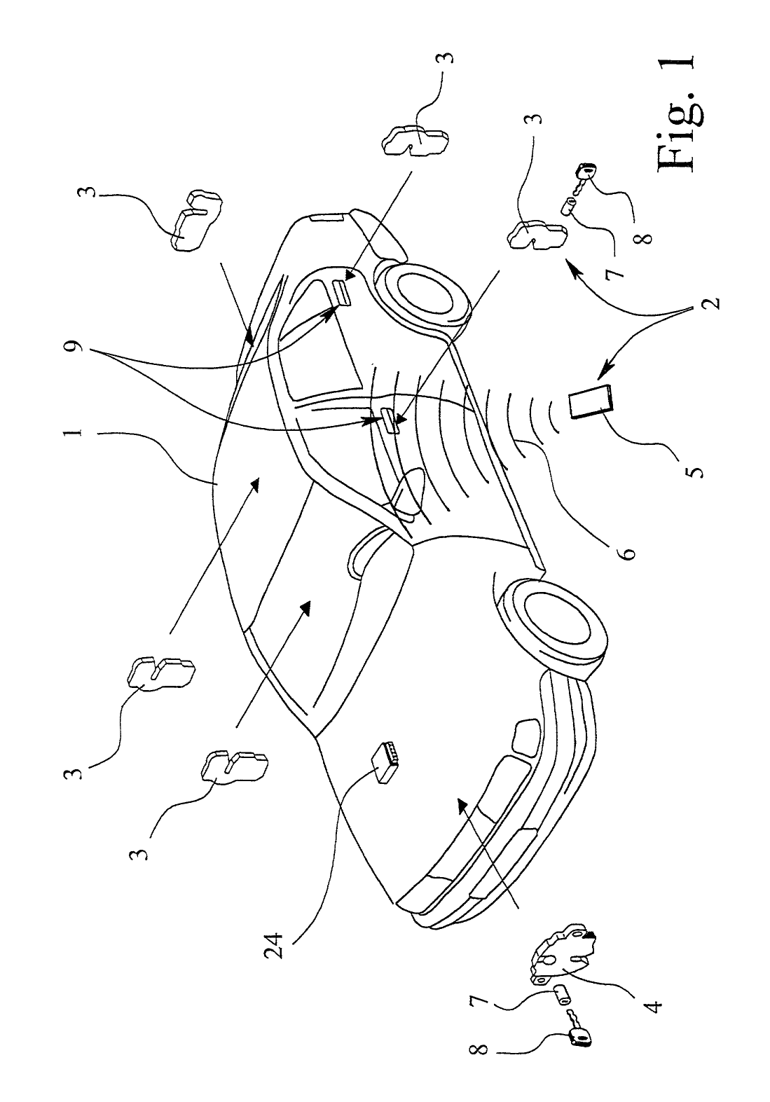

Referring now to the drawings, FIG. 1 schematically shows a motor vehicle 1 with a vehicle door lock system 2 having a plurality of vehicle locks 3 for the vehicle doors, the rear hatch and the like, and a hood lock 4 with installation positions. Preferably, each motor vehicle lock 3 can be locked and unlocked by a motor such as an electric motor having a conventional central interlock or a central interlock drive. Each motor vehicle lock 3 may additionally include a motorized opening to lift the detent pawl (not shown) by means of an opening drive (not shown). The locking and unlocking can also be done through the exclusive use of circuitry. In a second embodiment, the motor vehicle locks 3 include an auxiliary closing drive which can be identical to the opening drive or can be separate from it.

The motor vehicle door lock system 2 is preferably equipped with a passive entry function including a data medium made such as a passive entry chip card or other data medium or transponder 5 which is carried and used as an electronic key by the operator of the vehicle. Thus, data interrogation or identification of the data medium or the transponder 5 can be carried out and the access authorization of the operator can be checked. This may be accomplished by signal waves 6 emitted from the transponder 5 to the motor vehicle driver-side door. With the corresponding access authorization, the motor vehicle locks 3 are unlocked by means of a conventional central interlock system (not shown) or the like. A lock cylinder 7 and a mechanical key 8 is assigned to the motor vehicle lock 3 for use with the driver-side door and the hood lock 4. Thus, the motor vehicle lock 3 of the driver-side door and hood lock 4 can be mechanically actuated or unlocked in the event of an emergency using the key 8. In addition, there can be a corresponding emergency unlocking or opening for the other motor vehicle locks 3.

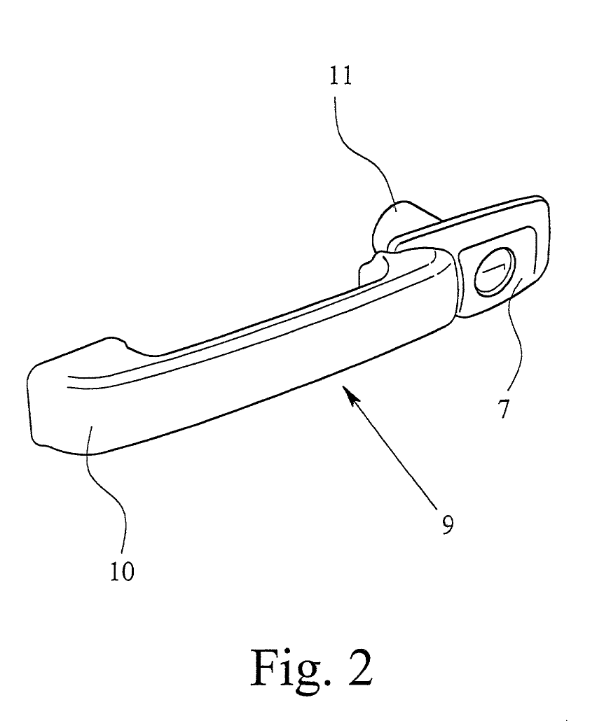

As shown in FIG. 1, an outside door handle arrangement 9 is assigned to at least each motor vehicle door lock 3 of the motor vehicle side doors. FIG. 2 shows the outside door handle arrangement 9 of the driver-side door with an integrated lock cylinder 7. The outside door handle arrangement 9 further includes an outside door handle 10 which is movably supported and interacts with an assigned switching means 11 of the outside door handle arrangement 9. In operation, when the outside door handle 10 is pulled by the operator, a switching signal is triggered in order to drive an assigned opening drive (not shown) for opening the assigned motor vehicle lock 3 or to lift the detent pawl of the corresponding motor vehicle lock 3. In a mechanically actuated motor vehicle lock 3, instead of a switching means 11 there is a conventional transfer mechanism or other actuation detection means. But the switching means 11 can also be omitted when the outside door handle 10 is not movably supported and instead sensing of proximity and contact is accomplished to automatically open the assigned motor vehicle lock 3. The outside door handle arrangement 9 can additionally include an adjacent door area (not shown).

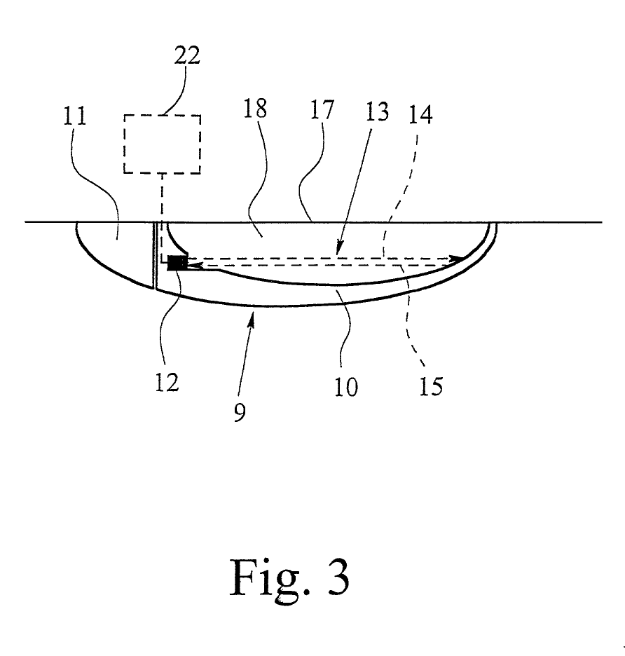

FIG. 3 shows in a schematic overhead view the outside door handle arrangement 9, which can be made without the lock cylinder 7. In this embodiment, there is an electrically drivable or operable ultrasonic transducer 12 integrated into the outside door handle 10. The ultrasonic transducer 12 can produce an ultrasonic field 13 which is emitted as ultrasonic waves 14, and reflected ultrasonic waves 15. The ultrasonic transducer 12 works both as a transmitter and a receiver, with the ultrasonic waves 14 preferably being emitted in pulses which pauses the reflected ultrasonic waves 15 being acquired. Accordingly, while only a single ultrasonic transducer 12 is shown, a plurality of ultrasonic transducers 12 which operate in the same manner can be mounted on the outside door handle 10 and/or on an assigned door area.

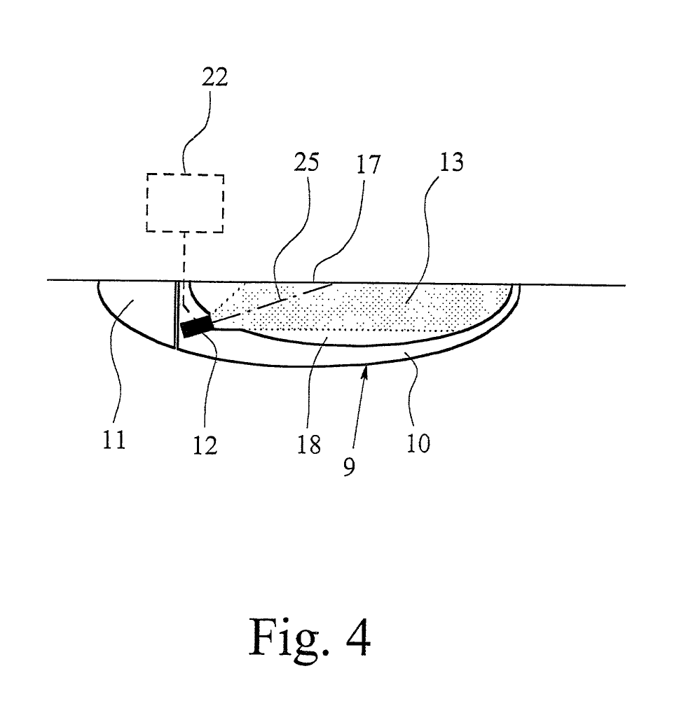

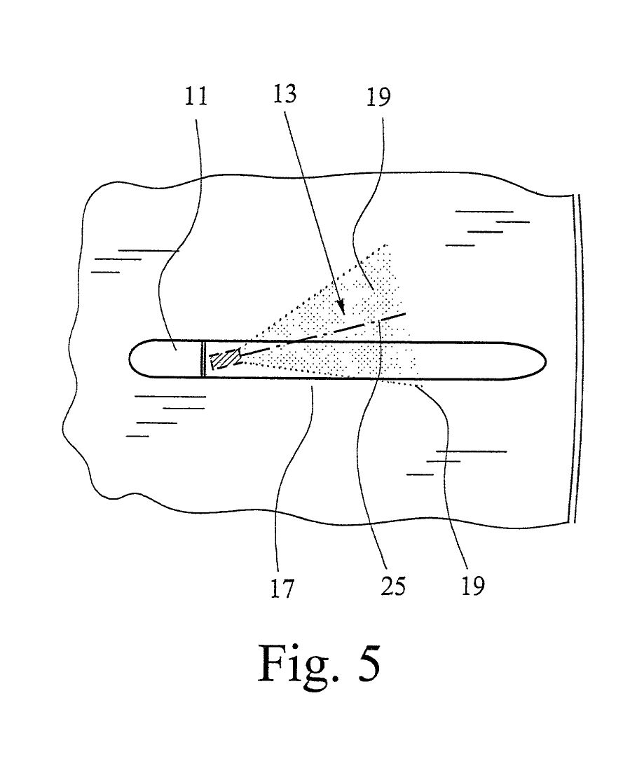

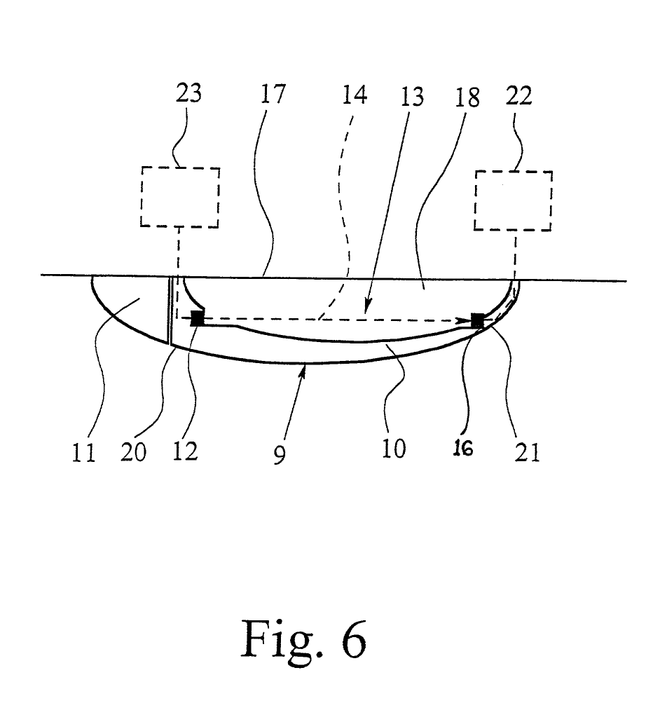

FIGS. 4 and 5 illustrate a second embodiment of the outside door handle arrangement 9 in accordance with the present invention, including a single ultrasonic transducer 12 which works both as the transmitter and receiver, similarly to in the first embodiment. FIG. 6 shows a third embodiment of the outside door handle arrangement 9 in accordance with the present invention, including an additional ultrasonic transducer 16 placed on the outside door handle 10 for use as a receiver for acquiring the ultrasonic waves 14 emitted by the ultrasonic transducer 12. The ultrasonic transducers 12, 16 may include a piezoelement comprising a small, economical device having a comparatively lower power demand and available in various suitable embodiments for installation into the outside door handle 10. In particular, there is essentially a linear sound propagation between the two ultrasonic transducers 12, 16 operating as the transmitter and receiver. But the ultrasonic transducers 12, 16 can be arranged in closer spatial proximity to one another for a sonic connection which is not directly linear, but with acquisition of reflected sonic waves. Moreover, the ultrasonic transducers 12, 16 may be mounted on sections 20, 21 of the outside door handle 10 at a distance far away as possible from one another in order to enable monitoring of the access space 18 as accurately as possible.

As shown in FIGS. 3, 4 and 6, in operation, an ultrasonic field 13 is produced at least temporarily in an access space 18 formed between the outside door handle 10 and the adjacent door panel area 17. The adjacent door panel area 17 may include a handle well or the like which is inserted or molded into the outside door panel skin. The “access space” is defined as the space into which the hand of an operator ordinarily reaches when activating the outside door handle 10. To minimize the power demand for the proximity or contact sensing, the ultrasonic field 13 is produced at least essentially solely in the access area 18. In addition, and as illustrated in FIG. 5, the ultrasonic field may also be produced in the spatial areas 19 surrounding the door handle 10.

In the following description, the detection of the proximity of the hand of an operator to the outside door handle 10 and the touching of the outside door handle 10 by the hand of an operator is detailed. For acquisition and evaluation purposes, the motor vehicle lock system includes an evaluation unit including a controller 22 for controlling or driving the ultrasonic transducers 12, 16. Optionally, as shown in FIG. 6, there is a second controller 23. The controllers 22, 23 are preferably integrated into the outside door handle arrangement 9, preferably within the outside door handle 10. Alteratively, the controllers 22, 23 can be at least partially integrated into an assigned motor vehicle door or into a central motor vehicle controller 24 for the vehicle 1.

As shown in FIG. 3, the ultrasonic waves 14 are emitted preferably in pulses transmitted by the ultrasonic transducer 12. The ultrasonic waves 14 are reflected by a stationary part, such as the outside door handle 10, towards the ultrasonic transducer 12 which reacquires the reflected ultrasonic waves 15, especially in the transmission pauses. The direction of primary emission of the ultrasonic waves 14 runs preferably parallel to the lengthwise extension of the outside door handle 10, and at least essentially parallel to the outside contour of the assigned motor vehicle door panel and especially essentially horizontally as a result of the generally conventional horizontal alignment of the outside door handle 10. If the hand of an operator is moved into the access space 18 in order to actuate the outside door handle 10, the ultrasonic field 13 is disturbed or interrupted. The failure of the reflected ultrasonic waves 15 to appear and/or the transit time change of the reflection signal are detected and evaluated as proximity to the outside door handle 10. In particular, a corresponding signal is output by the controller 22 to the central motor vehicle controller 24.

As shown in FIGS. 4 and 5, in the second embodiment, the ultrasonic transducer 12 preferably emits ultrasonic waves in pulses 25. In contrast to the first embodiment, the pulses are not reflected back to the ultrasonic transducer 12 to any great degree by the outside door handle arrangement 9 or the outside door handle 10. The direction of primary emission of the pulses 25 relative to the lengthwise extension of the outside door handle arrangement 9 or the outside door handle 10 is slanted both in the vertical and horizontal plane, preferably upwards and towards the motor vehicle 1. For an access space 18 which is open only to the bottom, the direction of primary emission of the pulses 25 is preferably directed downward instead of upward. Preferably, the direction of primary emission of the pulses 25 therefore has a component or alignment pointed opposite the conventional access motion.

Only in instances when the hand of an operator is moved into the ultrasonic field 13, such as the spatial area 19 and/or the access space 18, does reflection of the ultrasonic waves 15 towards the ultrasonic transducer 12 take place. This event is acquired and detected as proximity or contact with the outside door handle 10 and the transit time of the ultrasonic waves 15 can be considered to differentiate between proximity and contact.

In the second embodiment, the direction of primary emission of ultrasonic waves 14 from the ultrasonic transducer 12 or the direction of primary extension of the ultrasonic field 13, can be acquired, detected and evaluated if provisions are made for at least few or essentially no reflections occurring on the outside door handle 10 or other parts of the outside door handle arrangement 9 in its return path back to the ultrasonic transducer 12. Optionally these reflections can be masked out by choosing a corresponding time window in the evaluation. The system may include a feedback means for controlling at least one of the frequency, pulse length, and amplitude of the transmitted and acquired ultrasonic waves.

In the third embodiment a more or less photoelectric barrier-like ultrasonic field is produced only in pulses 25, preferably to minimize the power demand. The ultrasonic transducer 12 emits ultrasonic waves 14 which strike the additional ultrasonic transducer 16 especially directly or optionally after reflection on parts or sections of the outside door handle arrangement 9 and are acquired. If the hand of an operator moves into the access space 18 or into the ultrasonic field 13, the ultrasonic field 13 between the ultrasonic transducers 12, 16 is disrupted or completely interrupted. This is acquired and evaluated as proximity to the outside door handle 10 or contact with the outside door handle 10. Depending upon the execution of the ultrasonic transducer 12, a hand located in the ultrasonic field 13 can also reflect ultrasonic waves which are acquired and evaluated as proximity or contact back to the ultrasonic transducer 12. This can take place additionally to the detection of an interruption or of proximity in order to achieve high response reliability.

The motor vehicle controller 24 preferably has a conventional passive entry function. In particular, to unlock the motor vehicle lock 3 or all motor vehicle locks 3 the motor vehicle controller 24 requires a time reaction phase with a starting interval, authorization check interval and the action interval. When proximity to the outside door handle 10 of any door, or at least the outside door handle 10 of the driver-side door, is sensed or detected, the motor vehicle controller 24 is activated to initiate the starting interval. Alternatively the activation takes place only upon detection or sensing of contact with any outside door handle 10 or the outside door handle 10 of the driver-side door. Early initiation of the starting internal and early checking of the access authorization of the operator who has approached or who is touching the outside door handle 10 are achieved by interrogation or identification of the operator-side data medium or transponder 5, with the result that the actual activation or pulling of the outside door handle 10 lasts so long that the action interval, generally the lifting of the detent pawl, can proceed seemingly without delay for the operator.

As already addressed, both proximity sensing and also contact sensing can take place. For example, the evaluation can output a first signal upon detection or sensing of spatial spatial proximity in order to start the passive entry function or the starting interval of the motor vehicle controller 24. Then, with the corresponding authorization and with a correspondingly time-correlated sensing of contact of the outside door handle 10 the central interlock can be unlocked and/or the assigned motor vehicle lock 3 can open. In the latter case, a switch assigned to the outside door handle 10 or the switching means 11 can be omitted. Then it is not even necessary to make or support the outside door handle 10 or part thereof to be movable.

The aforementioned measurement or evaluation methods of the preferred embodiments can also be optionally combined with one another. In addition, it should be pointed out that spatial proximity sensing and/or contact sensing can be used also to control other motor vehicle functions and to activate other motor vehicle controls. Preferably to do this the corresponding control signals can be output by the evaluation electronics 22 or other electronics.

We claim:

1. A motor vehicle door lock system comprising:
at least one vehicle lock;
an outside door handle assigned to the vehicle lock;
a sensor element for detecting at least one of spatial proximity of an operator to the outside door handle and a physical touching of the outside door handle by the operator;
wherein the sensor element comprises at least one ultrasonic transducer mounted in an area adjacent to the outside door handle, the at least one ultrasonic transducer producing an ultrasonic field including ultrasonic waves in an area proximate to the outside door handle and causes detection of said at least one of spatial proximity of an operator to the outside door handle and a physical touching of the outside door handle by the operator by acquiring interruptions in the ultrasonic field caused by said at least one of spatial proximity of an operator to the outside door handle and a physical touching of the outside door handle by the operator.

2. The motor vehicle door lock system according to claim 1, wherein the ultrasonic transducer is mounted as an integral part with the outside door handle.

3. The motor vehicle door lock system according to claim 1, wherein the ultrasonic transducer transmits and receives ultrasonic waves.

4. The motor vehicle door lock system according to claim 1, further comprising a second ultrasonic transducer mounted on an area adjacent to the door handle.

5. The motor vehicle door lock system according to claim 1, wherein the at least one ultrasonic transducer comprises a piezoelement.

6. The motor vehicle door lock system according to claim 1, wherein the ultrasonic field is produced in at least one of a direction parallel to the lengthwise extension of the outside door handle, an access space located between the outside door handle and a door panel, and in spatial areas above and below the access space of the outside door handle.

7. The motor vehicle door lock system according to claim 1, wherein the ultrasonic transducer transmits a pulsed emission of ultrasonic waves.

8. The motor vehicle door lock system according to claim 1, further comprising feedback means for controlling at least one of the frequency, pulse length, and amplitude of the emitted and acquired ultrasonic waves.

9. The motor vehicle door lock system according to claim 1, further comprising at least one controller for evaluating at least one of the interruption of the ultrasonic field and change in transit times of the ultrasonic waves of the ultrasonic field caused by the at least one of spatial proximity of an operator to the outside door handle and a physical touching of the outside door handle by the operator.

10. The motor vehicle door lock system according to claim 1, wherein the at least one ultrasonic transducers have measurement values that are averaged and assigned to the outside door handle.

11. The motor vehicle door lock system according to claim 1, wherein an output signal is transmitted to the at least one controller indicating the occurrence of at least one of spatial proximity of an operator to the outside door handle and a physical touching of the outside door handle by the operator.

12. The motor vehicle door lock system according to claim 1, further comprising a third controller for locking and unlocking the at least one motor vehicle lock.

13. The motor vehicle door lock system according to claim 13, wherein the third controller has a passive entry function with a reaction phase having a starting interval, an authorization check interval, and an action interval.

14. The motor vehicle door lock system according to claim 14, wherein the at least one of spatial proximity of an operator to the outside door handle and a physical touching of the outside door handle by the operator is acquired by the ultrasonic transducer and evaluated as a signal for initiating the starting interval.

15. An outside door handle arrangement for a motor vehicle, the outside door handle arrangement comprising:
an outside door handle for opening an assigned motor vehicle lock;
a door area adjacent to the outside door handle; and
at least one ultrasonic transducer mounted on at least one of the outside door handle and the door area,
wherein the ultrasonic transducer transmits an ultrasonic field in an area surrounding the outside door handle.

16. The outside door handle arrangement according to claim 16, wherein the at least one ultrasonic transducer receives ultrasonic waves from the ultrasonic field.

17. A process for controlling a motor vehicle door lock system having a motor vehicle lock and an outside door handle assigned to the motor vehicle lock, the process comprising the steps of:
producing an ultrasonic field including ultrasonic waves in an access space between at least one of an access space between the outside door handle, an access space between the outside door handle and a door panel area adjacent thereto, and sections directly above and below the access space, and
detecting using the ultrasonic waves at least one of spatial proximity of an operator to the outside door handle and a physical touching of the outside door handle by the operator,
wherein the detecting step includes acquiring interruptions in the ultrasonic field caused by the at least one of spatial proximity of an operator to the outside door handle and a physical touching of the outside door handle by the operator.

18. The process according to claim 17, further comprising the step of evaluating at least one of the occurrence of reflected ultrasonic waves in the ultrasonic field caused by the at least one of spatial proximity of an operator to the outside door handle and a physical touching of the outside door handle by the operator, the interruption in the ultrasonic field, and change of transit times in ultrasonic waves of the ultrasonic field.

19. The process according to claim 17, wherein the ultrasonic waves are emitted in pulses by a first ultrasonic transducer.

20. The process according to claim 19, wherein the ultrasonic waves transmitted by the first ultrasonic transducer are received by a second ultrasonic transducer.

21. The process according to claim 20, wherein the receipt of the ultrasonic waves by the second ultrasonic transducer is evaluated to detect at least one of spatial proximity of an operator to the outside door handle and a physical touching of the outside door handle by the operator.

22. The process according to claim 21, wherein, upon the detection of the occurrence of at least one of spatial proximity of an operator to the outside door handle and a physical touching of the outside door handle by the operator, at least one of checking an access authorization of the operator and activating a passive entry function is performed, thereby resulting in an activation of at least one of an interlock and opening mechanism of the motor vehicle lock.
